(19) United States
(12) Patent Application Publication
(10) Pub. No.: US 2003/0173464 A1
(43) Pub. Date: Sep. 18, 2003

(54) Spaceshuttle launched double observatory

(76) Inventor: Zoltan Herpay, London (GB)

Correspondence Address: Dr. Zoltan Herpay, 28 Dudley Court, 36 Endell Street, London, WC2H 9RD, GB

(21) Appl. No.: 10/100,731

(22) Filed: Mar. 18, 2002

(51) Int. Cl. B64G 1/22; B64G 1/00

(52) U.S. Cl. 244/158 R

(57) ABSTRACT

A Spaceshuttle launched and rescued Double Observatory, similar in shape to the Spaceshuttle Launched Observatory, but there is a difference inside the core of the fuselage, for instead of accommodating a singular observatoy and telescope tube, the central fuel tank is sandviching a full length of a tubular body to the outer fuel tank on a way that the double mirrored observatory and its two secondaries are al pushed up to the nose-cone of the fuselage, and these ar pulled down into position by the outgoing central fuel tank, which finally pull the long tube out, observatory at the centre, that may erect two or more wing-like radiation collectors, while the Spaceshuttle could receive the central fue tank back and it could go back to Earth with its probably many space-passengers taking the observatory back to the earth later.

This invention relates to a Spaceshuttle Launched Double Observatory.

The Spaceshuttle is known as a successful system ever since I submitted my British Patent Specification to the NASA in 1967, from which the NASA replaced the observatory and developed its own Spaceshuttle.

The Space-Observatory is also known, especially since the Hubble Telescope was repaired by an extra visiting party. Only its adequate reports are missing, due to the fact that it is a mediocre system, whose aim is not to observe many important facts, and leave the Universe as mysterious to the tax-payers as possible. Initiating still-born projects at grand scale investments for the escapists, who want to invade the Mars.

According to the present invention there is provided a Spaceshuttle Launched Double Observatory of a full length of a tubular body that could be sandwiched in the fuselage of the Shuttle between the outer and the inner fuel tanks, all the accessories of the observatory are pushed up to its upper end in launching, but as it arrives to space, the outslipping central fuel tank pulls all the accessories into position and finally pulls the whole telescope tube out into space, having two ends for observational purposes and extra surfaces for the opening of a number of radiation collecting wings, while the Spaceshuttle could rescue the jettisoned fuel tank and its main engine and it could go back to the earth with its probably many space-travellers.

The invention will now be describe by way of a specific embodiment as an exampl with reference to the accompanying drawing in which:

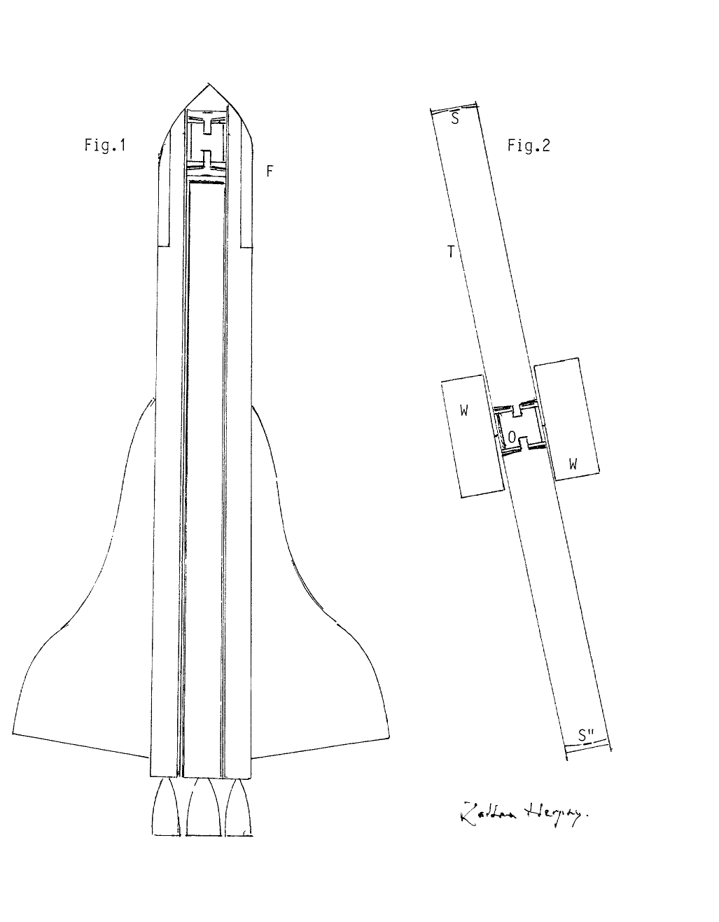

FIG. 1 shows the whole launching body.

FIG. 2 shows the fully opened telescope and observatory.

Referring to FIG. 1 the double observatory is a long sandwiched tubular body T, almost completely filled with a central fuel tank, and its accessories for the observatory are all pushed up to the top part of the fuselage F.

Referring to FIG. 2 the fully opened telescope is pulled out by the outslipping central fuel tank, first positioning the double observatory to the centre 0 of the tube, then positioning the second secondary mirror to the lower end,S, just before jettisonning itself from the telescope, that has two ends now for observational purposes, and plenty of surface areas for the erection of side-wings for radiation collection W.

After launching the observatory, the central fuel tank could be rescued by the Spaceshuttle before returning back to the earth.

1. A spaceshuttle Launched Double Observatory, comprising a long tubular body, sendwiched between the outer and the inner fuel tanks of the Spaceshuttle in which the accessories of the observatory are all pushed up to the top part in take off and/or in lanunching, but the observatory and its second secondary reflector is pulled into position by the outgoing central fuel tank, which finally pulls the whole telescope out into space.

2. A Spaceshuttle Launched Double Observatory that has two open ends for observations and two main reflectors on the sides of the centrally positioned drum-like observatory, and two secondaries at the two ends.

3. A Spaceshuttle Launched Double Observatory that can open from its outer surface one or more radiation collecting, rotatable, wing-like plates, all jettisoned before the rescue operation.

4. A Spaceshuttle Launched Double Observatory, which could be rescued by the launching spaceshuttle and it could be transported back to earth.

5. A Spaceshuttle Launched Double Observatory which could rescue even its empty and jettisoned central fuel tank, while its passengers might enjoy the whole launching, or rescuing operations in different times.
